(19) United States
(12) Patent Application Publication
(10) Pub. No.: US 2025/0033582 A1
(43) Pub. Date: Jan. 30, 2025

(54) OBJECT DETECTION DEVICE AND AUTHENTICATION METHOD

(71) Applicants: AISIN CORPORATION, Kariya-shi, Aichi (JP); HONDA MOTOR CO., LTD., Minato-ku, Tokyo (JP)

(72) Inventors: Takuya SAKIUCHI, Kariya-shi, Aichi-ken (JP); Koichi SASSA, Kariya-shi, Aichi-ken (JP); Akihiro OMURA, Kariya-shi, Aichi-ken (JP); Tatsuya WATANABE, Minato-ku, Tokyo (JP); Kohei TOSHIMA, Minato-ku, Tokyo (JP)

(73) Assignees: AISIN CORPORATION, Kariya-shi, Aichi (JP); HONDA MOTOR CO., LTD., Minato-ku, Tokyo (JP)

(21) Appl. No.: 18/565,170

(22) PCT Filed: Jun. 27, 2022
(86) PCT No.: PCT/JP2022/025610

§ 371 Date: Aug. 9, 2024

(30) Foreign Application Priority Data
Jun. 30, 2021 (JP) 2021-108338

(51) Int. Cl. B60R 16/023; H04L 9/40

(52) U.S. Cl. CPC B60R 16/023; H04L 63/08

(57) ABSTRACT

An object detection device according to an embodiment includes an assignment unit that assigns, at a predetermined timing, first identification codes uniquely representing installation positions in a vehicle to a plurality of transmission and reception devices that are installed in a plurality of places of the vehicle, and transmit and receive probe waves; a reading unit that reads second identification codes uniquely representing the plurality of transmission and reception devices from the plurality of transmission and reception devices at the predetermined timing; and a processing unit that authenticates the plurality of transmission and reception devices based on first combinations of the first identification codes assigned at the predetermined timing and the second identification codes read at the predetermined timing.

### TECHNICAL FIELD

The disclosure here relates to an object detection device and an authentication method.

### BACKGROUND ART

An object detection device detects an object around a vehicle by acquiring transmission and reception results of a probe wave from a plurality of transmission and reception devices installed on a plurality of places of the vehicle. The object detection device assigns an identification code uniquely representing, for example, an installation position in the vehicle to each of the plurality of transmission and reception devices and determines the installation position of each transmission and reception device based on these identification codes.

### CITATION LIST

### Patent Literature

Patent Literature 1: JP 2017-052386 A
Patent Literature 2: JP 2003-152741 A

### SUMMARY

### Problem to be Solved

However, a transmission and reception device to which the identification code is assigned may be reassembled to a vehicle, and there is a case where installation positions of the plurality of transmission and reception devices to the vehicle may be mistaken. In addition, a transmission and reception device belonging to another vehicle may be installed to a wrong vehicle.

The disclosure here is conceived in view of the above and provides an object detection device and an authentication method capable of detecting an error in installation of a transmission and reception device.

### Means for Solving Problem

In order to solve the above problem and achieve the object, an object detection device according to an embodiment includes: an assignment unit that assigns, at a predetermined timing, first identification codes uniquely representing installation positions in a vehicle to a plurality of transmission and reception devices that are installed in a plurality of places of the vehicle, and transmit and receive probe waves; a reading unit that reads second identification codes uniquely representing the plurality of transmission and reception devices from the plurality of transmission and reception devices at the predetermined timing; and a processing unit that authenticates the plurality of transmission and reception devices based on first combinations of the first identification codes assigned at the predetermined timing and the second identification codes read at the predetermined timing.

According to this configuration, it is possible to detect an error in installation of the transmission and reception device.

Further, in the above object detection device, a storage unit that stores data associating, for the plurality of transmission and reception devices, the first identification codes with the second identification codes assigned to the plurality of transmission and reception devices in advance is further included, and the processing unit collates second combinations of the first identification codes and the second identification codes in the data with the first combinations to verify whether they match to authenticate the plurality of transmission and reception devices. According to this configuration, since the data stored in advance is compared with the current data, it is possible to detect an error in installation of the transmission and reception device with high accuracy.

Further, in the above object detection device, when the first combinations and the second combinations match in one transmission and reception device out of the plurality of transmission and reception devices, the processing unit determines that authentication of the one transmission and reception device is successful. According to this configuration, it is possible to determine that the transmission and reception device is correctly installed.

Further, in the above object detection device, when the first combinations and the second combinations do not match in one transmission and reception device out of the plurality of transmission and reception devices, the processing unit determines that authentication of the one transmission and reception device is failed. According to this configuration, it is possible to determine that the transmission and reception device is incorrectly installed.

Further, in the above object detection device, when the authentication of the one transmission and reception device is failed, the processing unit outputs a collation result for the one transmission and reception device. According to this configuration, it is possible to notify a maintenance worker or the like that the transmission and reception device is incorrectly installed.

Further, in the above object detection device, the assignment unit assigns the first identification codes at least at factory shipment of the vehicle to include the first identification codes in the data, and the reading unit reads the second identification codes at least at factory shipment of the vehicle to include the second identification code in the data. According to this configuration, data serving as a basis of authentication can be correctly stored.

Further, in the above object detection device, the predetermined timing is a timing at which a traveling time of the vehicle at a predetermined speed or higher exceeds a predetermined period of time. According to this configuration, collation of the transmission and reception device can be appropriately performed in a state where the transmission and reception device is not used.

An authentication method according to an embodiment is executed by an object detection device that detects an object around a vehicle, and includes: assigning, at a predetermined timing, first identification codes uniquely representing installation positions in the vehicle to a plurality of transmission and reception devices that are installed in a plurality of places of the vehicle, and transmit and receive probe waves; reading second identification codes uniquely representing the plurality of transmission and reception devices from the plurality of transmission and reception devices at the predetermined timing; and authenticating the plurality of transmission and reception devices based on first combinations of the first identification codes assigned at the predetermined timing and the second identification codes read at the predetermined timing.

According to this configuration, it is possible to detect an error in installation of the transmission and reception device.

### BRIEF DESCRIPTION OF DRAWINGS

FIG. 1 is a block diagram illustrating a physical configuration of an object detection system according to an embodiment;

FIG. 2 is a block diagram illustrating a functional configuration of an ECU according to the embodiment;

FIG. 3 is a top view illustrating a vehicle equipped with a plurality of transmission and reception devices of the object detection system according to the embodiment at the time of factory shipment;

FIG. 4 is a top view illustrating the vehicle equipped with the plurality of transmission and reception devices of the object detection system according to the embodiment at a predetermined timing;

FIG. 5 is a flowchart illustrating an example of a procedure of a data storage method executed by the ECU according to the embodiment; and

FIG. 6 is a flowchart illustrating an example of a procedure of an authentication method executed by the ECU according to the embodiment.

### DESCRIPTION OF EMBODIMENTS

The same components in the following exemplary embodiments and the like are denoted by the same reference numerals, and redundant description is omitted as appropriate.

### Configuration Example of Object Detection System

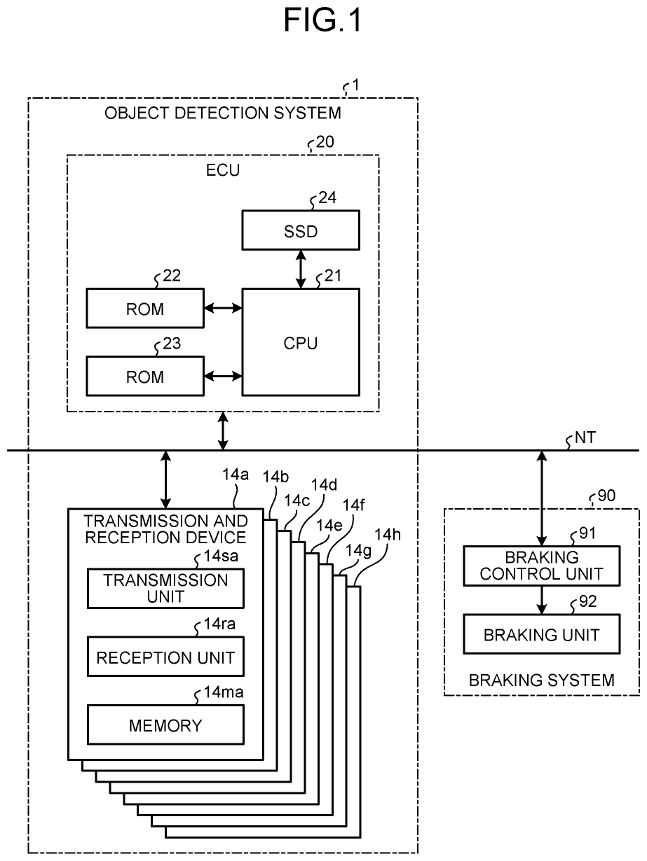

FIG. 1 is a block diagram illustrating a physical configuration of an object detection system 1 according to an embodiment. As illustrated in FIG. 1, the object detection system 1 according to the embodiment includes an electronic control unit (ECU) 20 and a plurality of transmission and reception devices 14a to 14h.

The ECU 20 and the plurality of transmission and reception devices 14a to 14h are connected via an in-vehicle network NT such as a controller area network (CAN) so as to be able to transmit and receive signals and data to and from each other. A braking system 90 is also connected to the in-vehicle network NT and is configured to be able to transmit and receive signals and data to and from the ECU 20.

The plurality of transmission and reception devices 14a to 14h are installed in different positions of the vehicle and are configured as sensors or sonars that transmit and receive probe waves such as ultrasonic waves. The transmission and reception device 14a

includes a transmission unit 14sa, a reception unit 14ra, and a memory 14ma. Hereinafter, the transmission unit 14sa, the reception unit 14ra, and the memory 14ma of the transmission and reception device 14a are described. Similarly to the transmission and reception device 14a, each of the transmission and reception devices 14b to 14h also includes a transmission unit, a reception unit, and a memory (not illustrated) and has functions and configurations similar to those of the transmission and reception device 14a.

The transmission unit 14sa of the transmission and reception device 14a transmits a probe wave such as an ultrasonic wave to the surroundings. The reception unit 14ra of the transmission and reception device 14a receives the probe wave reflected by the surrounding object. The transmission and reception device 14a transmits the transmission and reception result of the probe wave by the transmission unit 14sa and the reception unit 14ra to the ECU 20 via the in-vehicle network NT.

The memory 14ma of the transmission and reception device 14a is, for example, a nonvolatile memory or the like and maintains data even when the power supply of the transmission and reception device 14a is turned off. Information on the transmission and reception device 14a is stored in the memory 14ma.

Note that the number and the like of the transmission and reception devices 14a to 14h installed in one vehicle are arbitrary and are not limited to the example of FIG. 1. Hereinafter, when the individual transmission and reception devices 14a to 14h are not distinguished, the devices are also simply referred to as transmission and reception devices 14.

The ECU 20 as an object detection device is configured as a computer including, for example, a central processing unit (CPU) 21, a read only memory (ROM) 22, a random access memory (RAM) 23, and a solid state drive (SSD) 24 and detects an obstacle or the like around the vehicle.

The CPU 21 is an example of a hardware processor, reads a program stored in the ROM 22 or the like, and executes various arithmetic processing and control according to the program.

The ROM 22 stores programs, parameters necessary for executing the programs, and the like. The RAM 23 functions as a work area of the CPU 21. The SSD 24 is a rewritable nonvolatile storage device and maintains data even when the power supply of the ECU 20 is turned off. The SSD 24 stores information related to installation positions and the like of the plurality of transmission and reception devices 14a to 14h.

However, some or all of the above-described functions of the ECU 20 may be realized by hardware such as a circuit including, for example, an application specific integrated circuit (ASIC) or a field-programmable gate array (FPGA).

The braking system 90 includes a braking control unit 91 and a braking unit 92. The braking control unit 91 is configured as a computer such as an ECU and controls the braking unit 92 based on the detection result of the object acquired from the ECU 20 via the network NT. The braking unit 92 is, for example, a brake for stopping the vehicle.

### Functional Configuration Example of ECU

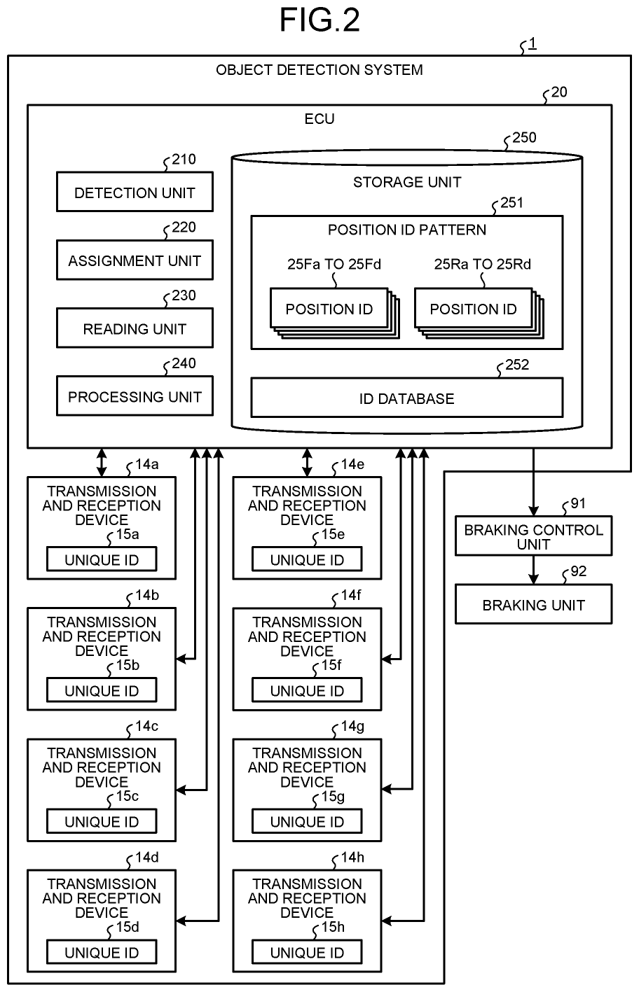

Next, a functional configuration example of the ECU 20 according to the embodiment is described with reference to FIG. 2. FIG. 2 is a block diagram illustrating a functional configuration of the ECU 20 according to the embodiment.

As illustrated in FIG. 2, the ECU 20 according to the embodiment includes a detection unit 210, an assignment unit 220, a reading unit 230, a processing unit 240, and a storage unit 250. These functional units of the ECU 20 are realized, for example, by the above-described CPU 21 loading the program read from the ROM 22 into the RAM 23 and executing the program.

With the respective functional units described above, the ECU 20 functions as an object detection device that detects an object such as an obstacle around the vehicle based on the transmission and reception results of the probe wave acquired from the plurality of transmission and reception devices 14a to 14h.

The detection unit 210 acquires the transmission and reception result of the probe wave from each of the plurality of transmission and reception devices 14a to 14d. The transmission and reception result of the probe wave includes, for example, information such as the transmission time and the reception time of the probe wave in each of the plurality of transmission and reception devices 14a to 14d, and the intensity of the received probe wave.

Based on this information, the detection unit 210 detects an object around the vehicle and transmits a detection result to the braking control unit 91. The detection result of the object includes, for example, information on whether an object such as an obstacle exists around the vehicle, information on the position of the object with respect to the vehicle when the object exists, and information on the distance from the vehicle to the object.

The object detection system 1 according to the embodiment is configured to avoid collision between surrounding obstacles and a vehicle, for example, when the vehicle is parked in a predetermined parking space. Therefore, transmission and reception of probe waves by the plurality of transmission and reception devices 14a to 14d, object detection processing by the detection unit 210, and the like are executed exclusively when the vehicle is traveling at a speed lower than a predetermined speed.

The braking control unit 91 transmits a control signal to the braking unit 92 based on the detection result of the object acquired from the ECU 20. For example, the braking unit 92 configured as a brake or the like stops the vehicle based on the control signal from the braking control unit 91.

The assignment unit 220 assigns a position ID to each of the plurality of transmission and reception devices 14a to 14h installed to a plurality of places of the vehicle, for example, at the time of the factory shipment of the vehicle or at a predetermined timing after the factory shipment.

The position ID as the first identification code is a code string in which at least any of a number, an alphabet, a symbol, other characters, and the like uniquely representing installation positions of the plurality of transmission and reception devices 14a to 14h in the vehicle is combined. The pattern of the position ID is determined, for example, for each vehicle type, for each type of transmission and reception device, or according to other standards.

The assignment unit 220 reads, for example, a position ID pattern 251 stored in advance in the storage unit 250 and assigns position IDs 25Fa to 25Fd and 25Ra to 25Rd to each of the plurality of transmission and reception devices 14a to 14h according to the position ID pattern 251.

The reading unit 230 reads the unique ID retained by each of the plurality of transmission and reception devices 14a to 14h from each of the plurality of transmission and reception devices 14a to 14h installed to a plurality of places of the vehicle, for example, at the time of the factory shipment of the vehicle or at a predetermined timing after the factory shipment.

The unique ID as the second identification code is a code string in which at least any of a number, an alphabet, a symbol, other characters, and the like uniquely representing each of the plurality of transmission and reception devices 14a to 14h is combined. More specifically, according to the unique ID, each of the transmission and reception devices including the plurality of transmission and reception devices 14a to 14h can be uniquely represented.

The transmission and reception devices including the plurality of transmission and reception devices 14a to 14h refer to not only the plurality of transmission and reception devices 14a to 14h but also, for example, a transmission and reception device and the like of the same type as the plurality of transmission and reception devices 14a to 14h and refers to a plurality of transmission and reception devices that can be installed in a vehicle and the like of the same type as the plurality of transmission and reception devices 14a to 14h. Therefore, the unique ID retained by each transmission and reception device 14 can be based on, for example, a serial number assigned to each transmission and reception device 14.

In the example of FIG. 2, the plurality of transmission and reception devices 14a to 14h respectively retain unique IDs 15a to 15h. These unique IDs 15a to 15h are stored, for example, in the above-described memories 14ma (FIG. 1) and the like provided in the transmission and reception devices 14a to 14h, respectively.

Note that the predetermined timing at which the position IDs are assigned to the plurality of transmission and reception devices 14a to 14h, and the unique IDs are read is, for example, a timing at which the vehicle is traveling at a predetermined speed or higher. When the vehicle is traveling at a high speed equal to or higher than a predetermined speed, for example, the object detection processing is not executed, and the plurality of transmission and reception devices 14a to 14h are not in use.

The vehicle continues traveling at a predetermined speed or higher for a certain period of time, and at the predetermined timing exceeding the predetermined period of time, the assignment unit 220 assigns the position IDs to the plurality of transmission and reception devices 14a to 14h, and the reading unit 230 reads the unique IDs from the plurality of transmission and reception devices 14a to 14h.

The processing unit 240 executes various kinds of processing related to the position IDs and the unique IDs described above.

Specifically, the processing unit 240 generates data associating, for example, position IDs assigned at the time of the factory shipment of the vehicle with, for example, unique IDs read at the time of the factory shipment of the vehicle, for the plurality of transmission and reception devices 14a to 14h. In addition, the processing unit 240 generates an ID database 252 including data for each of the plurality of transmission and reception devices 14a to 14h and stores the ID database in the storage unit 250.

Furthermore, the processing unit 240 authenticates each of the plurality of transmission and reception devices 14a to 14h based on, for example, a combination as a first combination of the position ID assigned at the predetermined timing and the unique ID read at the predetermined timing for each of the plurality of transmission and reception devices 14a to 14h.

More specifically, the processing unit 240 collates, for the plurality of transmission and reception devices 14a to 14h, the combination of the position ID and the unique ID at the predetermined timing with a combination as a second combination of the position ID and the unique ID included in the ID database 252 stored in the storage unit 250 to verify whether they match.

In a case where these combinations match in the predetermined transmission and reception device 14, the processing unit 240 determines that the transmission and reception device 14 is successfully authenticated. This means that the transmission and reception device 14 that is successfully authenticated is an authorized product correctly installed to a predetermined place of the vehicle.

In a case where these combinations do not match in the predetermined transmission and reception device 14, the processing unit 240 determines that the authentication of the transmission and reception device 14 is failed. The transmission and reception device 14 for which the authentication is failed means that the installation position to the vehicle is incorrect or that the transmission and reception device is an unauthorized product that is installed to a wrong vehicle.

When there is a transmission and reception device 14 for which authentication is failed, the processing unit 240 outputs a collation result for the transmission and reception device 14. In a case where the collation result of the authentication failure is output, the processing unit 240 may display the collation result on, for example, a monitor or the like provided in the vehicle interior or may turn on a warning lamp indicating that there is a malfunction in the predetermined transmission and reception device 14 in the vehicle interior.

The storage unit 250 is a functional unit realized by, for example, the SSD 24 under the control of the CPU 21 that is executing the program of the ROM 22 described above. The storage unit 250 stores, for example, the position ID pattern 251 and the ID database 252.

In the position ID pattern 251, for example, patterns of position IDs such as position IDs 25Fa to 25Fd and 25Ra to 25Rd are defined. The ID database 252 includes data for each of the plurality of transmission and reception devices 14a to 14h in which a position ID at the time of factory shipment of the vehicle is associated with a unique ID by the processing unit 240.

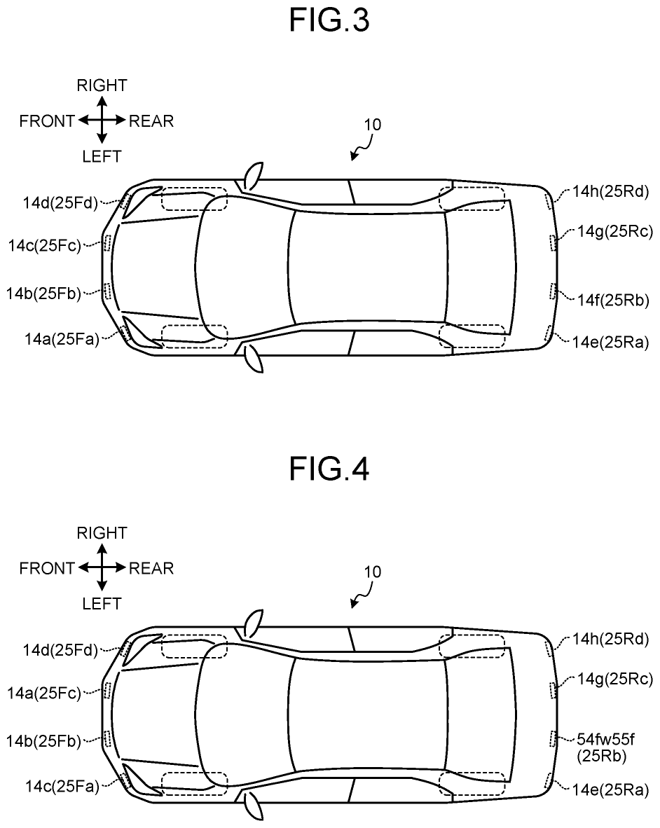

(Operation Example of ECU) Next, an operation example of the ECU 20 according to the embodiment is described with reference to FIGS. 3 and 4. FIG. 3 is a top view illustrating a vehicle 10 equipped with the plurality of transmission and reception devices 14a to 14h of the object detection system 1 according to the embodiment at the time of factory shipment. As indicated by arrows in FIG. 3, the front-rear and left-right directions as viewed from the driver's seat are the front-rear and left-right directions of the vehicle 10.

As illustrated in FIG. 3, at the time of factory shipment of the vehicle 10, the plurality of transmission and reception devices 14a to 14h is provided on the outer peripheral portion of the vehicle 10.

The plurality of transmission and reception devices 14a to 14d are installed to, for example, a front bumper of the vehicle 10 at predetermined intervals from the left side to the right side of the vehicle 10 in this order. Specifically, the transmission and reception devices 14b and 14c are arranged on the left and right of the center of the front portion of the vehicle 10, respectively, and the transmission and reception devices 14a and 14d are arranged on both sides of the transmission and reception devices 14b and 14c, respectively.

The plurality of transmission and reception devices 14e to 14h are installed to, for example, a rear bumper of the vehicle 10 at predetermined intervals from the left side to the right side of the vehicle 10 in this order. Specifically, the transmission and reception devices 14f and 14g are arranged on the left and right of the center of the rear portion of the vehicle 10, respectively, and the transmission and reception devices 14e and 14h are arranged on both sides of the transmission and reception devices 14f and 14g, respectively.

However, installation positions and an installation number of the plurality of transmission and reception device 14 in the vehicle 10 are arbitrary and are not limited to the example of FIG. 3.

Note that the unique IDs 15a to 15h are respectively set in the plurality of transmission and reception devices 14a to 14h, after the manufacturing of the transmission and reception devices 14a to 14h until the installation to the vehicle 10.

In this state, the assignment unit 220 of the ECU 20 refers to, for example, the position ID pattern 251 of the storage unit 250 and assigns the position IDs 25Fa to 25Fd and 25Ra to 25Rd to each of the plurality of transmission and reception devices 14a to 14h.

In the example of FIG. 3, the position IDs 25Fa to 25Fd uniquely representing respective installation positions are assigned to the plurality of transmission and reception devices 14a to 14d installed to the front portion of the vehicle 10. Also, the position IDs 25Ra to 25Rd uniquely representing respective installation positions are assigned to the plurality of transmission and reception devices 14e to 14h installed to the rear portion of the vehicle.

Furthermore, in the above state, the reading unit 230 reads the unique IDs 15a to 15h retained by the plurality of transmission and reception devices 14a to 14h from the plurality of transmission and reception devices 14a to 14h, respectively.

The processing unit 240 generates data in which the position ID and the unique ID are associated with each other for each of the plurality of transmission and reception devices 14a to 14h and stores the data in the storage unit 250 as the ID database 252.

That is, the ID database 252 includes data related to the transmission and reception device 14a in which the position ID 25Fa and the unique ID 15a are associated, data related to the transmission and reception device 14b in which the position ID 25Fb and the unique ID 15b are associated, data related to the transmission and reception device 14c in which the position ID 25Fc and the unique ID 15c are associated, and data related to the transmission and reception device 14d in which the position ID 25Fd and the unique ID 15d are associated.

Furthermore, the ID database 252 includes data related to the transmission and reception device 14e in which the position ID 25Ra and the unique ID 15e are associated, data related to the transmission and reception device 14f in which the position ID 25Rb and the unique ID 15f are associated, data related to the transmission and reception device 14g in which the position ID 25Rc and the unique ID 15g are associated, and data related to the transmission and reception device 14h in which the position ID 25Rd and the unique ID 15h are associated.

FIG. 4 is a top view illustrating the vehicle 10 equipped with the plurality of transmission and reception devices 14a to 14h of the object detection system 1 according to the embodiment at a predetermined timing.

As described above, after the vehicle 10 is shipped from the factory, the ECU 20 collates the combination of the current position IDs and unique IDs of the plurality of transmission and reception devices 14a to 14h with the data of the ID database 252 of the storage unit 250, for example, per predetermined timing. FIG. 4 illustrates a state after some of the plurality of transmission and reception devices 14a to 14h are reassembled at one of the predetermined timings.

After the factory shipment of the vehicle 10, an arbitrary number of transmission and reception device 14 may be reassembled after being once removed from the vehicle 10. Such reassembly of the transmission and reception device 14 can be performed, for example, when the transmission and reception device 14 is repaired or maintained or parts of the vehicle 10 near the transmission and reception device 14 are repaired or maintained.

When the transmission and reception device 14 is reassembled, a mistake in installation positions may be generated among the plurality of transmission and reception devices 14a to 14h installed in a plurality of places of the vehicle 10. In addition, a transmission and reception device belonging to another vehicle or a transmission and reception device that is not an authorized product such as a developed product may be incorrectly installed to the vehicle 10.

In the example of FIG. 4, among the plurality of transmission and reception devices 14a to 14h, the transmission and reception device 14a and the transmission and reception device 14c are installed in a misplaced manner, and a transmission and reception device 54f belonging to another vehicle is installed in a place where the transmission and reception device 14f is to be installed. It is assumed that the transmission and reception device 54f retains, for example, a unique ID 55f.

Under such situations, when the vehicle 10 continues traveling at a predetermined speed or higher, and a predetermined period of time elapses, the assignment unit 220 of the ECU 20 refers to, for example, the position ID pattern 251 of the storage unit 250 and assigns the position IDs 15Fa to 15Fd, and 15Ra to 15Rd to the plurality of transmission and reception devices 14a to 14e, 54f, 14g, and 14h, respectively.

Furthermore, under the above situation, the reading unit 230 reads the unique IDs 15a to 15e, 55f, 15g, and 15h from the plurality of transmission and reception devices 14a to 14e, 54f, 14g, and 14h, respectively.

the processing unit 240 collate, for the plurality of transmission and reception devices 14a to 14e, 54f, 14g, and 14h, the combination of the current position ID and unique ID with the combination of the position ID and unique ID in each data in the ID database 252 stored in the storage unit 250 to verify whether they match.

Among the plurality of transmission and reception devices 14a to 14e, 54f, 14g, and 14h, the transmission and reception devices 14b, 14d, 14e, 14g, and 14h are transmission and reception devices belonging to the vehicle 10 and are installed in correct positions of the vehicle 10, respectively.

Therefore, for these transmission and reception devices 14b, 14d, 14e, 14g, and 14h, the combination of the current position ID and the unique ID matches the combination of the position ID and the unique ID in the ID database 252. Therefore, the processing unit 240 determines that the authentication of the transmission and reception devices 14b, 14d, 14e, 14g, and 14h is successful.

Among the plurality of transmission and reception devices 14a to 14e, 54f, 14g, and 14h, the transmission and reception device 14a and the transmission and reception device 14c are transmission and reception devices belonging to the vehicle 10, but installation positions thereof are switched.

Therefore, at the installation position of the position ID 25Fa, the unique ID 15a in the ID database 252 does not match the current unique ID 15c, and the processing unit 240 determines that the authentication of the transmission and reception device 14c installed to the installation position of the position ID 25Fa is failed.

Also, at the installation position of the position ID 25Fc, the unique ID 15c in the ID database 252 does not match the current unique ID 15a, and the processing unit 240 determines that the authentication of the transmission and reception device 14a installed to the installation position of the position ID 25Fc is failed.

Among the plurality of transmission and reception devices 14a to 14e, 54f, 14g, and 14h, the transmission and reception device 54f is a transmission and reception device of another vehicle incorrectly installed to the vehicle 10.

Therefore, at the installation position of the position ID 25Rb, the unique ID 15f in the ID database 252 does not match the current unique ID 55f, and the processing unit 240 determines that the authentication of the transmission and reception device 54f installed to the installation position of the position ID 25Rb is failed.

The processing unit 240 outputs a collation result indicating that the authentication for the transmission and reception devices 14a, 14c, and 54f is failed. As a result, an owner or a maintenance worker of the vehicle 10 can know that an incorrect transmission and reception device is installed to the installation position of the position IDs 25Fa, 25Fc, and 25Rb.

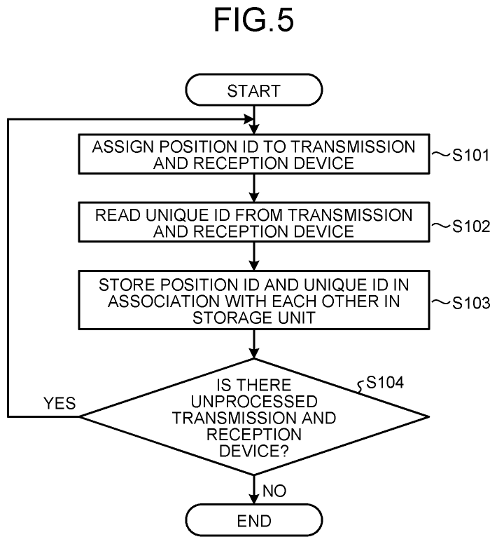

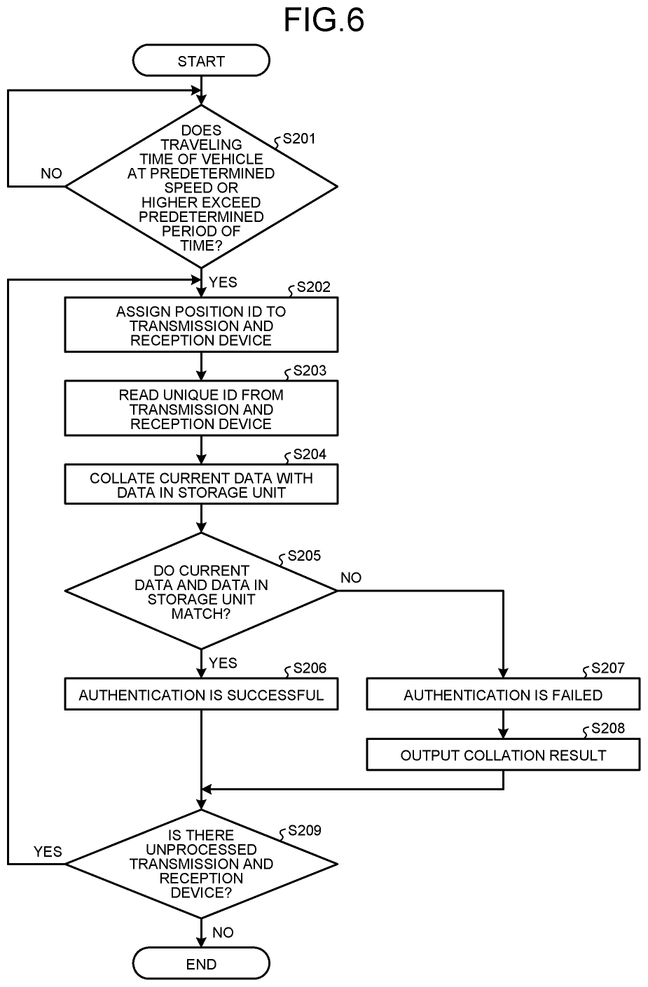

(Processing Example in ECU) Next, an example of various kinds of processing executed by the ECU 20 according to the embodiment is described with reference to FIGS. 5 and 6. FIG. 5 is a flowchart illustrating an example of a procedure of a data storage method executed by the ECU 20 according to the embodiment. The processing illustrated in FIG. 5 is executed, for example, at the time of factory shipment of the vehicle 10.

As illustrated in FIG. 5, the assignment unit 220 of the ECU 20 assigns a position ID corresponding to an installation position to the transmission and reception device 14 installed in a predetermined position of the vehicle 10 according to the position ID pattern 251 stored in the storage unit 250, for example (step S101).

The reading unit 230 reads the unique ID retained by the transmission and reception device 14 from the transmission and reception device 14 (step S102).

The processing unit 240 generates data associating the position IDs assigned to the transmission and reception devices 14 and the unique IDs read from the transmission and reception devices 14 and stores the data in the storage unit 250 so as to be included in the ID database 252 (step S103).

When there is an unprocessed transmission and reception device 14 among the plurality of transmission and reception devices 14a to 14h installed in the vehicle 10 (step S104: Yes), the ECU 20 repeats the processing from step S101. In a case where there is no unprocessed transmission and reception device 14 (step S104: No), the processing ends.

As described above, data storage processing executed by the ECU 20 according to the embodiment ends. FIG. 6 is a flowchart illustrating an example of

a procedure of an authentication method executed by the ECU 20 according to the embodiment. It is assumed that the ID database 252 is stored in advance in the storage unit 250 of the ECU 20 before the processing illustrated in FIG. 6.

As illustrated in FIG. 6, the ECU 20 waits until a predetermined timing at which the traveling time of the vehicle 10 at a predetermined speed or higher exceeds a predetermined period of time (step S201: No). At the predetermined timing (step S201: Yes), the assignment unit 220 of the ECU 20 assigns a position ID corresponding to an installation position to the transmission and reception device 14 installed in a predetermined position of the vehicle 10 according to the position ID pattern 251 stored in the storage unit 250, for example (step S202).

The reading unit 230 reads the unique ID retained by the transmission and reception device 14 from the transmission and reception device 14 (step S203).

The processing unit 240 collates the current data with the data in the storage unit 250 for the transmission and reception device 14 (step S204). That is, the processing unit 240 collates the combination of the position ID assigned to the transmission and reception device 14 in the processing of step S202 and the unique ID read from the transmission and reception device 14 in the processing of step S203 with the combination of the position ID and the unique ID in the data for the transmission and reception device 14 included in the ID database 252 of the storage unit 250.

For the above-described transmission and reception device 14, in a case where the combination of the position ID and the unique ID in the current data and the combination of the position ID and the unique ID in the data of the storage unit 250 match (step S205: Yes), the processing unit 240 determines that the authentication of the transmission and reception device 14 is successful (step S206).

For the above-described transmission and reception device 14, in a case where the combination of the position ID and the unique ID in the current data and the combination of the position ID and the unique ID in the data of the storage unit 250 do not match (step S205: No), the processing unit 240 determines that the authentication of the transmission and reception device 14 is failed (step S207).

The processing unit 240 outputs a collation result indicating that the authentication for the transmission and reception device 14 is failed (step S208).

When there is an unprocessed transmission and reception device 14 among the plurality of transmission and reception devices 14a to 14h installed in the vehicle 10 (step S209: Yes), the ECU 20 repeats the processing from step S202. In a case where there is no unprocessed transmission and reception device 14 (step S209: No), the processing ends.

As described above, authentication processing executed by the ECU 20 according to the embodiment ends.

### (Overview)

An object detection device that detects an object around a vehicle based on a transmission and reception result of a probe wave from a transmission and reception device is known. In order to identify each of the plurality of transmission and reception devices installed in the outer peripheral portion of the vehicle, the object detection device assigns, for example, an ID indicating an installation position of the transmission and reception device to each transmission and reception device.

When the transmission and reception device is once removed and then installed to the vehicle again for repair, maintenance, or the like of the transmission and reception device, the transmission and reception device may be reassembled with an incorrect installation position. In this case, the ID of the transmission and reception device indicates an installation position different from the actual installation position, and the object detection device may erroneously detect, for example, that an object is present at a position different from the actual position.

According to the technique of Patent Literature 1 described above, the plurality of ultrasonic sensors retain the present IDs assigned by the ECU at the time of factory shipment of the vehicle. When it is determined whether these sensors are erroneously installed at positions different from the original positions, the ECU assigns temporary IDs to individual sensors. Each of the sensors determines whether the present ID retained by the sensor matches the temporary ID newly assigned. As a result, when an error occurs in the installation position among the plurality of sensors, this can be detected.

However, when the ECU assigns the present ID at the time of factory shipment, an ID according to a predetermined ID pattern is generally assigned. For this reason, it is likely that there are a plurality of sensors having the common present ID between different vehicles, and in the technology of Patent Literature 1, it is not possible to detect a mistake in sensors between vehicles.

The ECU according to the embodiment authenticates each of the plurality of transmission and reception devices 14a to 14h based on a combination of a position ID uniquely representing an installation position in the vehicle 10 and a unique ID uniquely representing each of the plurality of transmission and reception devices 14a to 14h. As a result, it is possible to detect the error in installation of the transmission and reception device 14 not only when the installation positions are mistaken in the same vehicle 10 but also when the installation positions are mistaken between the vehicles.

Note that, in the above-described embodiment, the assignment of the position ID and the reading of the unique ID stored in the storage unit 250 are performed at the time of factory shipment of the vehicle 10. However, the assignment of the position ID and the reading of the unique ID to be stored in the storage unit 250 may be performed, for example, at a timing when the transmission and reception device 14 is initialized.

The initialization of the transmission and reception device 14 may be performed by the ECU 20 when, for example, an operation abnormality or the like occurs in the transmission and reception device 14. In addition, the initialization of the transmission and reception device 14 may be manually performed by, for example, a maintenance worker or the like even when the failed transmission and reception device 14 is replaced with another transmission and reception device 14. By appropriately updating the data in the storage unit 250 by assigning the position ID and reading the unique ID even at the initialization timing of the transmission and reception device 14, it is possible to maintain the information of the correct combination of the position ID and the unique ID for each transmission and reception device 14 and to improve the accuracy of the authentication process by the ECU 20.

Furthermore, in the above-described embodiment, one transmission and reception device 14 is installed in one place of the vehicle 10, but the above-described embodiment can be applied even in a case where a plurality of transmission and reception device 14 is installed in one place.

### EXPLANATIONS OF LETTERS OR NUMERALS

1 OBJECT DETECTION SYSTEM
10 VEHICLE
14a to 14h TRANSMISSION AND RECEPTION DEVICE
15a to 15h UNIQUE ID
20 ECU
25Fa to 25Fd, 25Ra to 25Rd POSITION ID
90 BRAKING SYSTEM
210 DETECTION UNIT
220 ASSIGNMENT UNIT
230 READING UNIT
240 PROCESSING UNIT
250 STORAGE UNIT

1. An object detection device comprising:
an assignment unit that assigns, at a predetermined timing, first identification codes uniquely representing installation positions in a vehicle to a plurality of transmission and reception devices that are installed in a plurality of places of the vehicle, and transmit and receive probe waves;
a reading unit that reads second identification codes uniquely representing the plurality of transmission and reception devices from the plurality of transmission and reception devices at the predetermined timing; and
a processing unit that authenticates the plurality of transmission and reception devices based on first combinations of the first identification codes assigned at the predetermined timing and the second identification codes read at the predetermined timing.

2. The object detection device according to claim 1, further comprising:
a storage unit that stores data associating, for the plurality of transmission and reception devices, the first identification codes with the second identification codes assigned to the plurality of transmission and reception devices in advance,
wherein the processing unit collates second combinations of the first identification codes and the second identification codes in the data with the first combinations to verify whether they match to authenticate the plurality of transmission and reception devices.

3. The object detection device according to claim 2,
wherein, when the first combinations and the second combinations match in one transmission and reception device out of the plurality of transmission and reception devices, the processing unit determines that authentication of the one transmission and reception device is successful.

4. The object detection device according to claim 2,
wherein, when the first combinations and the second combinations do not match in one transmission and reception device out of the plurality of transmission and reception devices, the processing unit determines that authentication of the one transmission and reception device is failed.

5. The object detection device according to claim 4,
wherein, when the authentication of the one transmission and reception device is failed, the processing unit outputs a collation result for the one transmission and reception device.

6. The object detection device according to claim 2, wherein
the assignment unit assigns the first identification codes at least at factory shipment of the vehicle to include the first identification codes in the data, and
the reading unit reads the second identification codes at least at factory shipment of the vehicle to include the second identification code in the data.

7. The object detection device according to claim 1,
wherein the predetermined timing is a timing at which a traveling time of the vehicle at a predetermined speed or higher exceeds a predetermined period of time.

8. An authentication method executed by an object detection device that detects an object around a vehicle, comprising:
assigning, at a predetermined timing, first identification codes uniquely representing installation positions in the vehicle to a plurality of transmission and reception devices that are installed in a plurality of places of the vehicle, and transmit and receive probe waves;
reading second identification codes uniquely representing the plurality of transmission and reception devices from the plurality of transmission and reception devices at the predetermined timing; and
authenticating the plurality of transmission and reception devices based on first combinations of the first identification codes assigned at the predetermined timing and the second identification codes read at the predetermined timing.
